(19) United States
(12) Patent Application Publication
(10) Pub. No.: US 2025/0175838 A1
(43) Pub. Date: May 29, 2025

(54) MULTIPLE TRANSCEIVER POINT OPERATION

(71) Applicant: Nokia Technologies Oy, Espoo (FI)

(72) Inventors: Brajesh SONI, Bangalore (IN); Smita Shetty, Bangalore (IN); Sreekanth K, Bangalore (IN); Riikka Karoliina Dimnik, Espoo (FI); Rafael Cauduro Dias De Paiva, Aalborg (DK)

(21) Appl. No.: 18/883,567

(22) Filed: Sep. 12, 2024

(30) Foreign Application Priority Data
Nov. 24, 2023 (GB) 2317977.3

(51) Int. Cl. H04W 24/10; H04W 76/15

(52) U.S. Cl. CPC H04W 24/10; H04W 76/15

(57) ABSTRACT

This application relates to multiple transceiver point operation. In an example embodiment, a method comprises signaling to a network node, before being connected to the network node, using a measurement report, that the user equipment has an interest in connecting to the network node using multiple transceiver points.

### RELATED APPLICATION

This application claims priority to, and the benefit of, GB Application No. 2317977.3, filed on Nov. 24, 2023, the contents of which is incorporated herein by reference in its entirety.

### TECHNOLOGICAL FIELD

Examples of the disclosure relate to multiple transceiver point (mTRP) operation. Some relate to improved set-up of mTRP operation.

### BACKGROUND

When a user equipment is connected to a cell, it can in some circumstances transition from using a single transceiver point (TRP) to using multiple transceiver points. A transceiver point is also called a transmission reception point.

The multiple TRP can be used by the user equipment for multiple reception and/or multiple transmission. The user equipment can in some examples comprise multiple antennas and can use the TRPs simultaneously.

The transition to using multiple TRPs could, for example, be used to provide reception diversity at the user equipment, or increased bandwidth at the user equipment (for example, multiple-input multiple-output, carrier aggregation, dual connectivity).

However, such a transition can suffer from some problems. For example, the current serving cell may not support the transition or it may not be known whether or not the current serving cell supports the transition. Currently a user equipment can confirm that the current serving cell can support the transition, however, this can introduce latency. It would be desirable to avoid or reduce latency in setting-up multiple TRP operation for the user equipment.

### BRIEF SUMMARY

According to various, but not necessarily all, examples there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

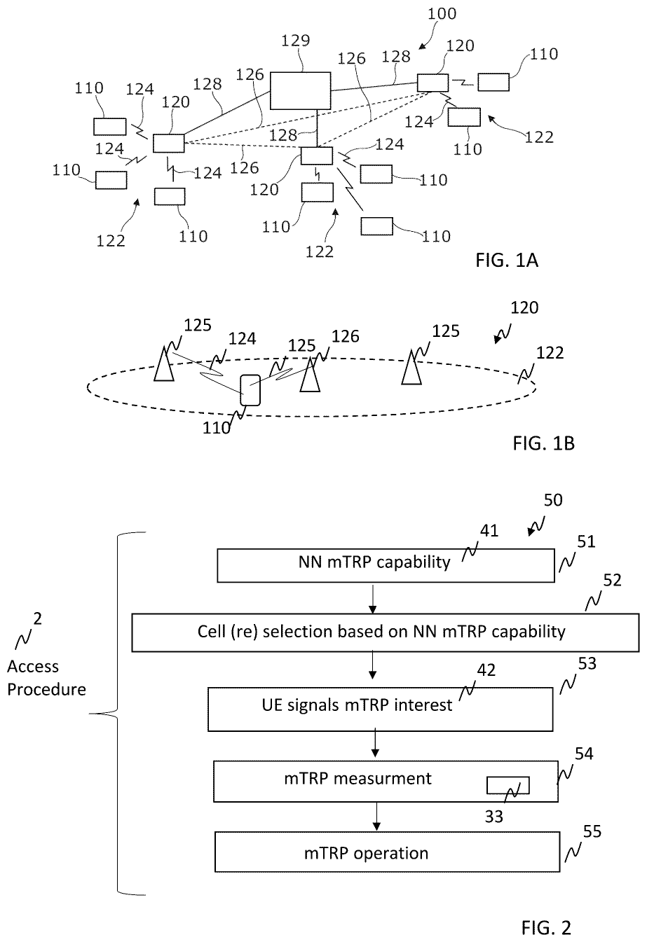

FIG. 1A shows an example of the subject matter described herein;

FIG. 1B shows an example of the subject matter described herein;

FIG. 2 shows another example of the subject matter described herein;

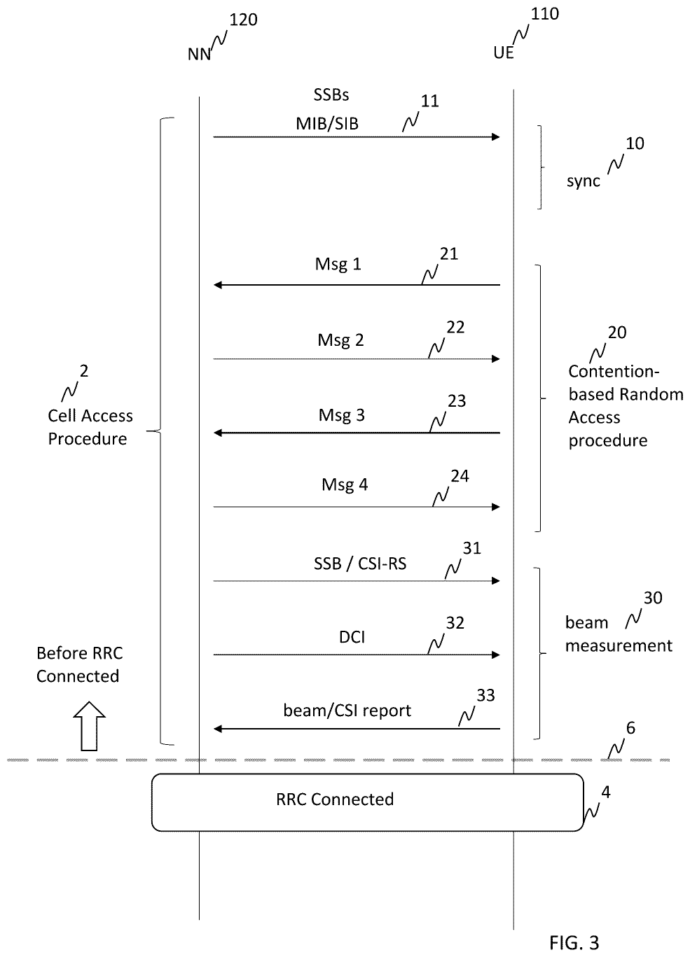

FIG. 3 shows another example of the subject matter described herein;

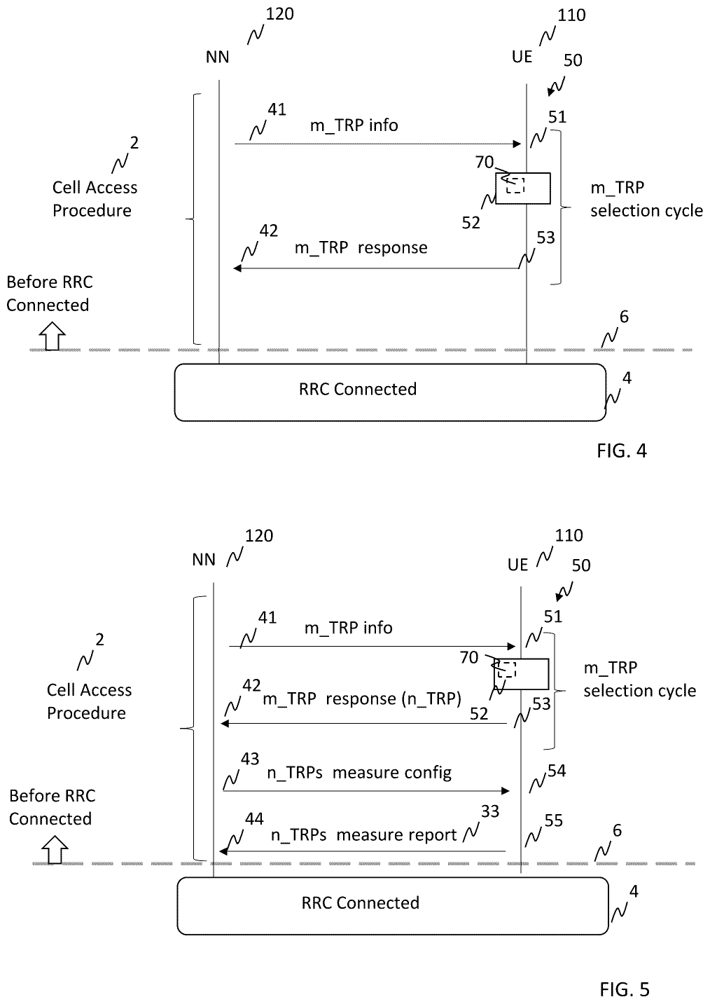

FIG. 4 shows another example of the subject matter described herein;

FIG. 5 shows another example of the subject matter described herein;

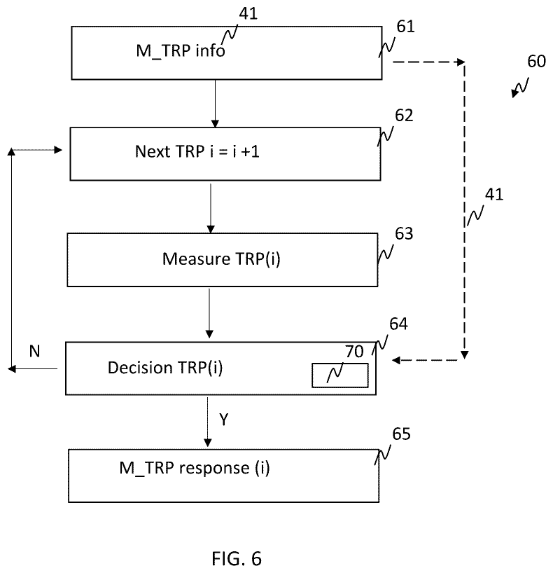

FIG. 6 shows another example of the subject matter described herein;

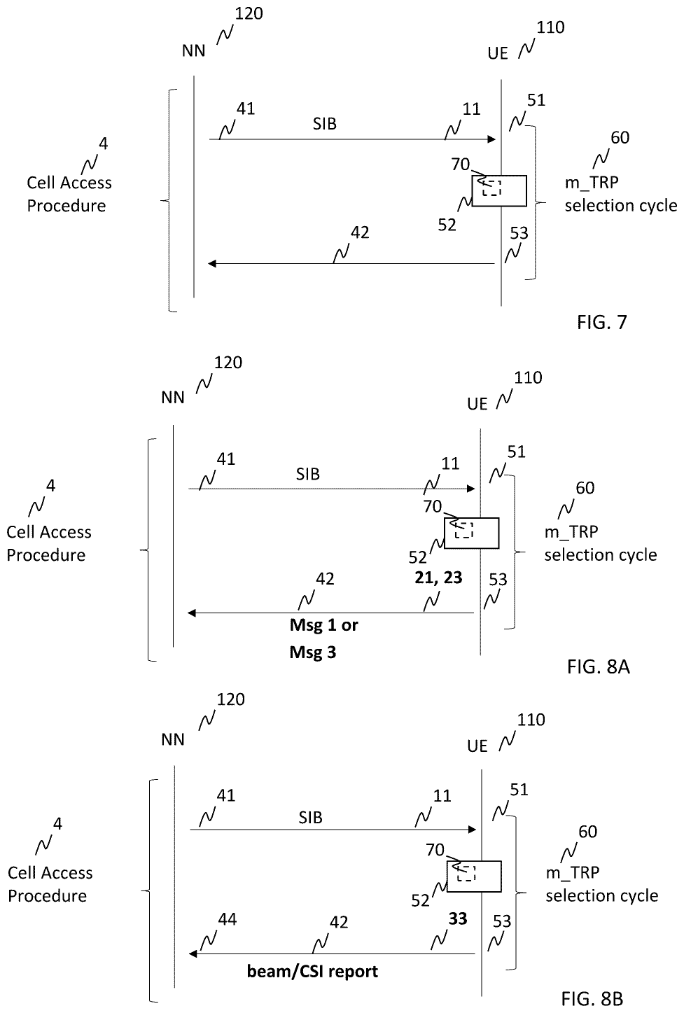

FIG. 7 shows another example of the subject matter described herein;

FIGS. 8A & 8B show other examples of the subject matter described herein;

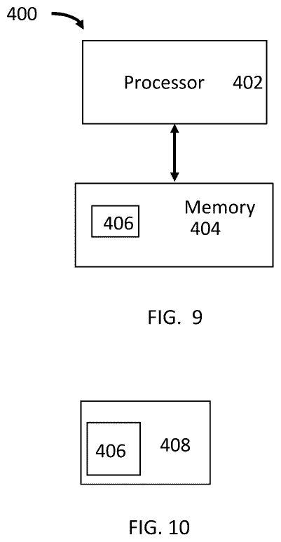

FIG. 9 shows another example of the subject matter described herein;

FIG. 10 shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

FIG. 1A illustrates an example of a network 100 comprising a plurality of network nodes including terminal nodes 110, access nodes 120 and one or more core nodes 129. The terminal nodes 110 and access nodes 120 communicate with each other. The one or more core nodes 129 communicate with the access nodes 120.

The network 100 is in this example a radio telecommunications network, in which at least some of the terminal nodes 110 and access nodes 120 communicate with each other using transmission/reception of radio waves.

The one or more core nodes 129 may, in some examples, communicate with each other. The one or more access nodes 120 may, in some examples, communicate with each other.

The network 100 may be a cellular network comprising a plurality of cells 122 each served by an access node 120. In this example, the interface between the terminal nodes 110 and an access node 120 defining a cell 122 is a wireless interface 124.

The access node 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) and the access nodes 120 are base stations.

In example illustrated the network 100 is a Next Generation (or New Radio, NR) Radio Access network (NG-RAN). The NG-RAN consists of gNodeBs (gNBs) 120, providing the user plane and control plane (RRC) protocol terminations towards the UE 110. The gNBs 120 are interconnected with each other by means of an X2/Xn interface 126. The gNBs are also connected by means of the N2 interface 128 to the Access and Mobility management Function (AMF) 129.

In other examples the network 100 is an Evolved Universal Terrestrial Radio Access network (E-UTRAN). The E-UTRAN consists of E-UTRAN NodeBs (eNBs) 120, providing the E-UTRA user plane and control plane (RRC) protocol terminations towards the UE 110. The eNBs 120 are interconnected with each other by means of an X2 interface 126. The eNBs are also connected by means of the S1 interface 128 to the Mobility Management Entity (MME) 129.

A UE 110 comprises a mobile equipment. Where reference is made to user equipment (UE) that reference includes and encompasses, wherever possible, a reference to mobile equipment.

FIG. 1B illustrates an example of a network node 120 (an access node) that serves the cell 122 via one or multiple transceiver points (TRPs) 125. A transceiver point 125 can also be called a transmission reception point. A TRP 125 is configured to transmit to UEs 110 in the cell (downlink) and to receive transmission made by UEs 110 in the cell 122 (uplink) via a wireless interface 124. The network node 120 can use multiple transceiver points (mTRPs) 125 to communicate with a UE 110. The network node 120 can use multiple transceiver points (mTRPs) 125 to communicate simultaneously with the UE 110.

TRPs 125 of the same cell 122 use synchronization signal (SS) blocks, referred to as SSBs. SS Block (SSB) comprises the Synchronization Signals—the PSS (Primary Synchronization Signal), and SSS (Secondary Synchronization Signal)

The SSB is a SS/Physical broadcast channel (PBCH) block which is cell specific. In multiple transceiver point (mTRP) operation, a serving cell 122 can schedule the User Equipment (UE) 110 from two (or more) TRPs 125, providing better coverage, reliability and/or data rates for at least some physical uplink and downlink channels e.g. Physical Downlink Control Channel (PDCCH), Physical Downlink Shared Channel (PDSCH), Physical Uplink Shared Channel (PUSCH), Physical Uplink Control Channel (PUCCH).

System Information (SI) consists of a master information block (MIB) and one or more system information blocks (SIBs), which are divided into Minimum SI and Other SI. Minimum SI comprises mandatory information required for initial access and information for acquiring any other SIB. Minimum SI consists of: a master information block (MIB) which contains cell barred status information and essential physical layer information of the cell required to receive further system information, e.g. CORESET #0 configuration. The MIB on the physical broadcast channel (PBCH) provides the UE 110 with parameters (e.g. CORESET #0 configuration) for monitoring of PDCCH for scheduling PDSCH that carries the System Information Block 1 (SIB1). MIB is periodically broadcast on PBCH.

SIB1 defines the scheduling of other system information blocks and contains information required for initial access. SIB1 is also referred to as Remaining Minimum system information (RMSI) and is periodically broadcast on Downlink Shared Channel (DL-SCH) (e.g. physical downlink shared channel PDSCH) or sent in a dedicated manner on DL-SCH to UEs in Radio Resource Control (RRC) connected state (RRC_CONNECTED).

Other system information (SI) encompasses all SIBs not broadcast in the Minimum SI.

The minimum requirement for UE 110 to camp on a cell is to decode MIB and SIB1.

Downlink control information (DCI) schedules physical resources for downlink (physical downlink shared channel PDSCH) and uplink (physical uplink hared channel PUSCH).

There are two different operation modes to schedule mTRP PDSCH transmissions: single-DCI (s-DCI) and multi-DCI (m-DCI). For both modes, control of uplink and downlink operation can be done by physical layer and medium access control MAC layer, within the configuration provided by the radio resource control RRC layer. In single-DCI mode, the UE 110 is scheduled by the same DCI for the mTRPs and in multi-DCI mode, the UE 110 is scheduled by independent DCIs from each respective TRP 125. Furthermore, s-DCI and m-DCI are UE independent capabilities meaning a UE 110 may either support any one of these or both capabilities depending on its implementation. Furthermore, s-DCI and m-DCI are TRP independent capabilities meaning TRPs 125 may support any one of these or both capabilities depending on its implementation.

The Random Access procedure (RACH) is used in Initial Access, small data transmissions in Inactive and transition from RRC_Inactive to RRC_Connected as well as in beam failure recovery, connection re-establishment, handover, cell addition.

The contention-based Random-Access procedure, comprises:
i) The UE110 transmits to the network node 120 a random access request [Msg 1]
ii) The network node 120 transmits to the UE 110 a random access response [Msg 2]
iii) The UE110 transmits to the network node 120 a radio resource control (RRC) connection request e.g. rrcSetupRequest [Msg 3—scheduled transmission]
iv) The network node 120 transmits to the UE 110 a RRC Connections Setup e.g. rrcSetup [Msg 4—contention resolution]

Multiple PRACH preamble formats for the random access request [Msg 1] are defined with one or more PRACH OFDM symbols, and different CP and guard time. The PRACH preamble configuration are provided to the UE 110 in the system information.

An initial access is initiated by the UE 110 transmitting, to the network node 120, a random access request (Msg1). The initial access can be terminated by the UE 110 transmitting, to the network node 120, a first beam/CSI report after receiving a contention resolution message (Msg4, e.g. RRC connection setup).

Consecutive SSBs associated with different SSB indexes can be transmitted by a network node 120 using different beams for beam management. Initial beam detection is employed during the cell detection and RACH process.

During initial beam detection, the network node 120 transmits a sequence of multiple SSBs at intervals. Each SSB is transmitted via a specific beam and is identified by a unique SSB index. The UE 110 measures the signal strength of each SSB beam. From the measurement result, the UE 110 can identify the SSB index with the strongest signal strength. The SSB with the strongest signal strength is the best beam for the UE 110. The UE 110 can transmit the random access request [Msg 1] to the location which is mapped to a specific SSB beam ID of the best beam.

The UE 110 can send a Channel State Information (CSI) Report to the network node 120. This can report, inter alia, Channel Quality Information (CQI) and the SSB index of the best beams(s) e.g. SS/PBCH Resource Block Indicator (SSBRI). The CSI Report is also referred to as a beam measurement report.

FIG. 2 illustrates an example of a set-up process 50 for mTRP operation that occurs during the access procedure 2, also called the initial access procedure, which initiates UE 110 connection and is before the UE 110 is connected (e.g. RRC connected) to the network node 120.

Before the UE 110 is connected, means in the time period immediately preceding connection. It does not imply that connection has never previously occurred, although this is possible. It can occur, for example, during cell selection and it can occur for example during cell reselection. In at least some examples, the connection is a connection that enables uplink and/or downlink of unicast data. In at least some examples, the connection is a Layer 3 (network layer) connection. In at least some examples, the connection is a change in a state machine from an active/idle state to a connected stated (e.g. a RRC_Connected state). The RRC_Connected state enables, inter alia, transfer of unicast data to/from the UE and network controlled mobility including measurements (beam measurements and/or neighboring cell measurements).

This set-up process 50 makes UE 110 is aware of the network node's mTRP capabilities before connecting to the network node 120 and is able to setup mTRP operation as part of the initial access procedure.

The UE 110 is aware 51 of the network node's mTRP capabilities 41 during the initial access procedure 2 and before connecting to the network node 120. The UE 110 can, for example, receive, from a network node 120 before being connected to the network node 120, multi-transceiver point (mTRP) capability information 41 for the network node 120. This can, for example be received via system information (SI) such as a SIB, for example SIB1.

The UE 110 determines 52 whether to perform an access to the network node 120 (cell (re)selection), in dependence upon the multi-transceiver point (TRP) capability information 41 of the network node 120.

Cell selection allows a UE 110 to camp in a serving cell. Cell reselection allows a UE 110 to change serving cell and camp on a different, better cell. The network provides the configuration for cell reselection via SIB or dedicated message. Cell reselection can occur in RRC_INACTIVE or RRC_IDLE states.

The UE signals 53 to the network node 120 an interest in mTRP operation using a mTRP indication 42. This signaling can be integrated with other signaling performed before connection to the network node 120. For example, it can be integrated into the uplink messages used in the Random Access attach procedure such as Msg 1 or Msg 3. For example, it can be integrated into the uplink message used for beam management such as the beam measurement report 33.

In at least some examples, the UE 110 is configured by the network node 120 to perform 54 mTRP measurements and to send a measurement report, for example a beam measurement report 33, to the network node 120.

In at least some examples, the network node 120 and the UE 110 can then perform 55 mTRP communication before completing the connection.

FIG. 3 illustrates an example of a NR initial access procedure. The FIG illustrates a transition 6 from the cell access procedure 2 to the connected state 4. The connected state is a radio resource control (RRC) connected state.

The illustrated procedure comprises, before the transition 6 to the connected state 4, synchronization 10, and a cell access procedure 2 comprising a random access procedure 20 and an optional beam measurement procedure 30.

During the synchronization phase 10, the network node 120 transmits system information 11.

In some but not necessarily all examples, the system information is broadcast system information. In some but not necessarily all examples, the (broadcast) system information 11 is mandatory minimum system information (MSI). In some examples, the measurement system information 11 is remaining minimum system information (RMSI) and is periodically broadcast. In some but not necessarily all examples, the (broadcast) system information 11 is a system information block (SIB). In some but not necessarily all examples, the (broadcast) system information is SIB1. In some examples, the measurement system information 11 is SIB1.

The contention-based Random-Access procedure 20, comprises:
i) The UE110 transmits to the network node 120 a random access request 21 [Msg 1];
ii) The network node 120 transmits to the UE 110 a random access response 22 [Msg 2]
iii) The UE110 transmits to the network node 120 a radio resource control (RRC) connection request 23 e.g. rrcSetupRequest [Msg 3—scheduled transmission]
iv) The network node 120 transmits to the UE 110 a RRC Connections Setup 24 e.g. rrcSetup [Msg 4—contention resolution]

During the beam measurement procedure 30, the network node 120 transmits SSB/CSI-RS 31. This or a previous downlink message indicates to the UE 110 whether the network node 120 supports single-DCI (s-DCI) or multi-DCI (m-DCI).

The network node 120 transmits DCI 32.

The UE 110 transmits a beam measurement report 33 This can report the SSB index(es) of the best beams(s) e.g. SS/PBCH Resource Block Indicator (SSBRI).

The initial access is initiated by the UE transmitting, to the network node 120, a random access request (Msg1). The initial access can be terminated by the UE 110 transmitting, to the network node 120, a first beam/CSI report after receiving a contention resolution message (Msg4, e.g. RRC connection setup).

The initial access procedure can be used to perform the set-up process 50 for mTRP and before the UE 110 is connected (e.g. RRC connected) to the network node 120.

The UE 110 can, for example, receive, from a network node 120 before being connected to the network node 120, multi-transceiver point (mTRP) capability information 41 for the network node 120. This can, for example be received via system information 11.

The UE signals 53 to the network node 120 an interest in mTRP operation using a mTRP indication 42. This signaling can be integrated with other signaling performed before connection to the network node 120. For example, it can be integrated into the uplink messages used in the Random Access attach procedure such as Msg 1 (Random access request) 21 or Msg 3 (RRC connection request) 23. For example, it can be integrated into the uplink message used for beam management such as the beam measurement report 33.

FIG. 4 illustrates an example of a set-up process 50 for mTRP operation that occurs during the initial access procedure 2 and before the UE 110 is connected (e.g. RRC connected) to the network node 120.

The UE 110 is aware 51 of the network node's mTRP capabilities 41 during the initial access procedure 2 and before connecting to the network node 120. The UE 110 can, for example, receive, from a network node 120 before being connected to the network node 120, multi-transceiver point (mTRP) capability information 41 for the network node 120. This can, for example be received via system information (SI) such as a SIB, for example SIB1.

The mTRP capability information 41 indicates whether the network node 120 supports multiple mTRP operation in a cell (mTRP downlink transmission).

In at least some examples, the UE 110 is configured to receive, from the network node 120 before being connected 4 to the network node 120, system information 11 (not illustrated in FIG. 4) comprising multi-transceiver point (mTRP) capability information 41 for the network node 120.

The UE 110 detects a cell and decodes the system information 11 received from the network node 120.

The system information 11 is, for example, broadcast system information. The system information 11 can, for example, be mandatory minimum system information (MIS), for example, SIB 1. SIB1 can therefore be modified. The system information 11 can, for example, be a system information block (SIB). The SIB can, for example, be a minimum system information (MIS) SIB (e.g. SIB1). The SIB can, for example, be a remaining system information (RMSI) SIB (e.g. SIB2 or another SIB for example a new SIB).

In some examples, the mTRP capability information 41 is comprised within a channel measurements resource (CMR) of a system information block (SIB) and/or is comprised within a single/multi-downlink control information (s/m-DCI) of a system information block (SIB). The presence of a mTRP flag within CMR and s/m-DCI fields in SIB, can be an indication about the network node 120 mTRP capabilities (the mTRP capability information 41).

The UE 110 determines 52 whether to perform an access to the network node 120 (cell (re)selection), in dependence upon the multi-transceiver point (TRP) capability information 41 of the network node 120.

In at least some examples, the UE 110 is configured to select the cell for access, in dependence upon the mTRP capability information 41 indicating that the network node 120 supports mTRP operation for the cell, and the cell satisfying a cell selection criterion 70 for access.

The determination can, for example, use a cell selection criterion 70 based on measurements for the TRPs of the selected network node 120. If the mTRP capability information 41 indicates that the network node 120 supports mTRP operation in its associated cell and the UE 110 determines that the cell satisfies the cell selection criterion 70, the UE 110 selects the cell for initial access.

The selection criterion 70 can, for example, be based on received power at the user equipment 110 for multiple transceiver points of the cell and/or received quality at the user equipment 110 for multiple transceiver points of the cell.

In this example, the current network node 120 is determined as suitable for access if: the multi-transceiver point (TRP) capability information 41 for the selected network node 120 indicates that the current network node 120 supports multi-transceiver point (TRP) operation; and
the received signal level (e.g. reference signal received power (RSRP)) and/or the received signal power (e.g. a reference signal received quality (RSRQ)) for the current network node 120 passes the decision criterion 70.

In some but not necessarily all examples, the decision criterion 70 is controlled via the mTRP capability information 41 or other downlink information.

The cells offering mTRP can be prioritized. The UE 110 interested in mTRP operation can shortlist all available cells based on the cell selection criterion 70 and can give preference to mTRP enabled cells in case the UE 110 is interested in mTRP operation.

The user equipment, in some examples, is configured to select the cell for initial access, that supports mTRP operation and best satisfies the cell selection criterion 70 for initial access.

The cell selection criterion 70 can, for example, be based on having an available margin for Rx power and an available margin in quality of reception.

An example of a selection criterion 70 is SrxlevTRPs >0 AND SqualTRPs >0 i) Where, SrxlevTRPs—is Srxlev for a particular TRP, and SqualTRPs—is Squal for a particular TRP

In at least some examples: Srxlev=Qrxlevmeas−(Qrxlevmin+Qrxlevminoffset)−Pcompensation−Qoffsettemp Squal=Qqualmeas−(Qqualmin+Qqualminoffset)−Qoffsettemp

| | |
|---|---|
| Srxlev | Cell selection RX level value (dB) |
| Squal | Cell selection quality value (dB) |

| | |
|---|---|
| Qoffsetₜₑₘₚ | Offset temporarily applied to a cell (dB) |

| | |
|---|---|
| Qᵣₓₗₑᵥₘₑₐₛ | Measured cell RX level value (RSRP) |
| Qᵣₓₗₑᵥₘᵢₙ | Minimum required RX level in the |
| | cell (dBm) provided via SIB(s). |
| Q_{rxlevminoffset} | Offset to the signalled Qᵣₓₗₑᵥₘᵢₙ. |

| | |
|---|---|
| Q_{qualmeas} | Measured cell quality value (RSRQ) |
| Q_{qualmin} | Minimum required quality level in the cell (dB). |
| Q_{qualminoffset} | Offset to the signalled Q_{qualmin} |
| P_{compensation} | For FR1, |
| | For FR2, P_{compensation} is set to 0. |

The UE 110 signals 53 to the network node 120 that it has an interest in connecting to the network node 120 using multiple transceiver points (mTRP operation). The signaling 53 is before being connected to the network node 120 of that UE 110.

Thus in response to selecting the cell for initial access, the UE 110 can transmit 53, to the network node 120, a mTRP indication 42 indicating that the UE 110 is interested in mTRP operation.

This signaling 53 can be integrated with other signaling performed before connection to the network node 120. For example, it can be integrated into the uplink messages used in the Random Access attach procedure such as Msg 1 or Msg 3. For example, it can be integrated into the uplink message used for beam management such as the beam measurement report 33.

FIG. 5 illustrates an example of a set-up process 50 for mTRP operation that occurs during the initial access procedure 2 and before the UE 110 is connected (e.g. RRC connected) to the network node 120. The stages 51, 52, 53 are the same as FIG. 4 and will not be re-described.

The UE 110 is configured by the network node 120 to perform 54 mTRP measurements and to send a beam measurement report 33 to the network node 120.

Before a connection has been established between the UE 110 and the network node 120, the UE 110 receives, in response to transmitting the mTRP indication 42, a measurement configuration 43 for performing reception quality measurements separately for at least two TRPs of the selected cell.

The UE 110 is configured to:
i) receive from the network node 120, before being connected to the network node 120, a measurement configuration 43 for performing reception quality measurements separately for at least two transceiver points;
ii) perform 54, for example, before being connected to the network node 120, configured reception quality measurements separately for the at least two transceiver points in dependence upon the received measurement configuration 43; and
iii) transmit 55, for example, before being connected to the network node 120, at least a measurement report 44, to the network node 120, in dependence upon the configured reception quality measurements for the at least two transceiver points.

The measurement report 44 can, for example, indicate reception quality measurements separately for the at least two transceiver points.

The measurement report 44 can, for example, indicates reception quality that can be received simultaneously from at least two transceiver points.

The measurement configuration 43 can be sent from the network node 120 via any suitable downlink signalling. In the illustrated example, but not necessarily all examples, the measurement configuration 43 is sent separately to the mTRP capability information 41. In some examples, the network node 120 sends measurement configuration 43 in a SIB. In some examples, the network node 120 sends measurement configuration 43 in the RRC Connections Setup 24 e.g. rrcSetup [Msg 4—contention resolution].

The network node 120 can provide groups of CMR (SSB) resource sets where each resource is associated with different TRP's. Based on this the UE 110 in the CSI report 33 can report (M=2) L1-RSRP measurements from different CMR Resource sets.

In some examples (not illustrated), UE 110 is configured to decide whether or not to accept the provided measurement configuration 43 and send an acknowledgement of acceptance. If the measurement configuration 43 is accepted by UE 110, the UE 110 can send measurement reports/CSI reports 33 for channel measurements resource (CMR) sets.

The UE 110 can, for example, not accept the measurement configuration 43, if for example, the UE 110 has a low battery level or for another reason. The UE 110 can perform a soft reject and not reject the complete configuration but only configurations which UE 110 does not wish to perform. The network node 120 can provide resource information (DCI) to the UE 110 but schedule CMR(CSI/SSB) only after confirmation of acceptance by UE 110, before that network node 120 can utilize the resource for other purposes.

In some examples, the acknowledgement is implicit and in other examples explicit. For example, the provision of a s/m DCI preference by the UE 110 can indicate acceptance of the measurement configuration 43.

The network can use the resource for other purposes until acceptance. The UE 110 can provide acceptance of CMR (CSI or SSB) resource sets where each resource is associated with different TRP's.

Where the network node 120 provides a default or UE specific measurement configuration 43 via the RRC Connections Setup 24 e.g. rrcSetup [Msg 4—contention resolution], the UE 110 can indicate acceptance in rrcSetupComplete message.

In some examples, the UE 110 performs said reception quality measurements and transmits a measurement report 44, to the network node 120, indicating reception quality separately for TRPs.

In some examples, the UE 110 is configured to:
perform configured reception quality measurements separately and simultaneously for the at least two transceiver points in dependence upon the received measurement configuration 43; transmit at least a measurement report 44, to the network node 120, in dependence upon the configured simultaneous reception quality measurements for the at least two transceiver point.

In at least some examples, the measurement report 44 indicates reception quality measurements separately for the at least two transceiver points. In at least some examples, the reception quality measurements indicate reception quality that can be received simultaneously from the at least two transceiver points.

In at least some examples, the network node 120 and the UE 110 can then perform 55 mTRP communication before completing the connection. As soon as UE 110 provides the CSI report 33 to the network node 120, the network node 120 can start mTRP transmissions.

The CSI report can, for example, be a group-based report indicating which beams the UE 110 can receive simultaneously.

Thus as illustrated in FIGS. 4 & 5, the user equipment (UE) 110 is configured to: receive, from a network node 120 before being connected to the network node 120, multi-transceiver point (mTRP) capability information 41 for the network node 120; and determine whether to perform an access to the network node 120, in dependence upon the multi-transceiver point (TRP) capability information 41.

The network node 120 is configured to: transmit, before being connected to a user equipment 110, multi-transceiver point (mTRP) capability information 41 for the network node 120; and receive signaling, before connecting to the user equipment 110, indicating that the UE 110 has an interest in connecting to the network node 120 using multiple transceiver points.

The UE 110 is aware of the network node's mTRP capabilities before connecting to the network node 120 and is able to setup mTRP operation as part of the initial access procedure.

The UE 110 makes an informed decision, during the initial attach process, about (re)selecting a cell based on what functionalities/capabilities the cell supports. This will result in an efficient utilization of the UE capabilities viz a viz the functionalities being offered by the cell. It also allows the UE 110 and network to start scheduling communication via multiple TRPs in time division multiplexing (TDM) manner and prepare for simultaneous communication via different TRPs.

There is no need to establish connection to a cell if the cell does not support the required service (mTRP operation) which leads to improved resource utilization and reduced power consumption from UE perspective. In at least some examples, the UE 110 priorities mTRP cell over non mTRP cell.

Performing mTRP operation as part of the initial access procedure reduces signaling. Initial access is improved in cases where a UE 110 is interested in mTRP operation. The initial access is initiated by the UE 110 transmitting, to the network node 120, a random access request message (e.g. Msg1). The initial access can be terminated by the UE 110 transmitting, to the network node 120, a first beam/CSI report after receiving a contention resolution message (Msg4, e.g. RRC connection setup).

In some examples, the multi-transceiver point (mTRP) capability information 41 for the network node 120 is comprised in broadcast system information 11, for example in a SIB such as SIB1.

In some examples, the UE 110 signals to the network node 120, before being connected to the network node 120 that the UE 110 has an interest in connecting to the network node 120 using multiple transceiver points. This can for example occur in any suitable uplink message. For example during a random-access procedure and/or a connection setup procedure e.g. Msg 1 or Msg 3, or as part of a beam measurement report 33.

In some examples, the UE 110 is configured to signal to a network node 120, during a random-access procedure and/or a connection setup procedure, that the UE 110 has an interest in connecting to the network node 120 using multiple transceiver points.

In an example, the random-access request 21 [Msg 1] can be enhanced to convey the mTRP indication 42. In one example, the network node 120 can reserve/allocate certain preambles for UE 110 to indicate the need for mTRP operation and provide this configuration in the system information 11 e.g. SIB1. Thus the RACH preamble comprises the mTRP indication 42. Where Msg 1 is used, multiple PRACH preamble formats for Msg 1 are defined to allow the UE 110 to indicate an interest in connecting to the network node 120 using multiple transceiver points by selecting for use a particular PRACH preamble configuration.

In an example, the radio resource control (RRC) connection request 23 e.g. rrcSetupRequest [Msg 3—scheduled transmission] comprises the mTRP indication 42.

In some examples, the UE 110 is configured to signal to a network node 120, before being connected to the network node 120, using a beam measurement report 33, that the UE 110 has an interest in connecting to the network node 120 using multiple transceiver points.

The UE 110 can thus perform mTRP aware cell (re)selection. The network node 120 can start mTRP operation e.g. mTRP measurement during the cell attach procedure.

This can reduce the signaling time and latency by sharing a payload among multiple TRPs. After the UE 110 provides a CSI report (beam measurement report) 33 to the network node 120, the network node 120 can start mTRP transmissions.

In at least some examples, the beam management report informs the network node 120 which beams the UE 110 can receive simultaneously.

FIGS. 4 & 5 illustrates examples of a device/UE 110 comprising means for:
receiving, from a network node 120 before being connected to the network node 120, multi-transceiver point (mTRP) capability information 41 for the network node 120, wherein the mTRP capability information 41 indicates whether the network node 120 supports multiple mTRP operation in a cell; and
selecting the cell for initial access, in dependence upon the mTRP capability information 41 indicating that the network node 120 supports mTRP operation for the cell, and the cell satisfying a cell selection criterion 70 for initial access;
in dependence upon said selection, signaling to the network node 120, before being connected to the network node 120, that the UE 110 has an interest in connecting to the network node 120 using multiple transceiver points;
receiving from the network node 120, before being connected to the network node 120, a measurement configuration 43 for performing reception quality measurements separately for at least two transceiver points;
performing, optionally before being connected to the network node 120, configured reception quality measurements separately for the at least two transceiver points in dependence upon the received measurement configuration 43;
transmitting, optionally before being connected to the network node 120, at least a measurement report 44, to the network node 120, in dependence upon the configured reception quality measurements for the at least two transceiver points, wherein the measurement report indicates reception quality measurements separately for the at least two transceiver points.

FIGS. 4 & 5 illustrates examples of a network node 120 comprising means for:
broadcasting, before being connected to a user equipment 110, multi-transceiver point (mTRP) capability information 41 for the network node 120, wherein the mTRP capability information 41 indicates whether the network node 120 supports multiple mTRP operation in a cell; and
receiving signaling, before being connected to the user equipment 110, indicating that the UE 110 has an interest in connecting to the network node 120 using multiple transceiver points;
transmitting, before being connected to the user equipment 110, a measurement configuration 43 for user equipment performance of reception quality measurements separately for at least two transceiver points;
receiving, before being connected to the user equipment 110, at least a measurement report 44, from the user equipment 110, in dependence upon the measurement configuration 43, wherein the measurement report 44 indicates reception quality measurements separately for the at least two transceiver points.

FIGS. 4 & 5 illustrate that cell (re)selection can, in at least some examples be performed using a selection cycle 60.

FIG. 6 illustrates an example of selection cycle 60 for cell (re)selection.

At block 61 the UE 110 receives via the system information 11 mTRP capability information 41 for a plurality of different network nodes 120.

At block 62, the UE 110 selects a first one of the different network nodes 120. The selection can be based on mTRP capability information 41 and a selection criteria 70 based on received power level for the network node 120 and/or received quality level for the network node 120. Alternatively the selection can be in order or random.

At block 63, the UE 110 performs measurements for the selected network node 120.

In the example illustrated the UE measurements for the selected network node 120 measure a received signal level for a signal transmitted by the selected network node 120 and/or a received signal quality for a signal transmitted by the selected network node 120. For example, the UE 110 can measure a reference signal received power (RSRP) and/or a reference signal received quality (RSRQ).

At block 64, the UE 110 determine whether to perform an access to the network node 120, in dependence upon the multi-transceiver point (TRP) capability information 41 for the selected network node 120. In this example, the determination at block 64 can, for example, also use a decision criterion 70 based on the measurements for the selected network node 120 performed at block 63.

In this example, the current network node 120 is determined as suitable for access if:
the multi-transceiver point (TRP) capability information 41 for the selected network node 120 indicates that the current network node 120 supports multi-transceiver point (TRP) operation; and
the received signal level (e.g. RSRP) and/or the received signal power (e.g. RSRQ) for the current network node 120 pass the decision criterion 70.

In some but not necessarily all examples, the decision criterion 70 is controlled via the mTRP capability information 41 of other downlink information.

If the current network node 120 is selected for access at block 64 the method moves to block 64. If the current network node 120 is not selected for access at block 64 the method moves to block 62, where the UE 110 selects a next one of the plurality of different network nodes 120 and the method repeats.

Thus, if the network node 120 supports multiple transceiver point (mTRP) operation in the cell and the UE 110 determines that the cell satisfies a cell selection criterion, the UE 110 selects the cell for initial access. Otherwise the UE 110 proceeds to checking next cell.

The UE 110 can proceed to selecting a next cell in case the network node 120 is not supporting mTRP operation; and if mTRP operation is supported, the network node 120 may start scheduling further messages over mTRPs right after the initial access.

In at least some examples, the UE 110 is configured to select the cell for initial access, that supports mTRP operation and satisfies the cell selection criterion 70 for initial access and to prevent selection of a cell for initial access, that does not support mTRP operation in dependence upon received mTRP capability information 41 associated with the cell.

In at least some examples, the network node 120 indicates, during the initial access, DCI capability and whether it supports s/m-DCI mode of operation.

The DCI capability can be sent with the mTRP capability information 41 or can be indicated separately in a downlink message. For example, the network node 120 can broadcast s-DCI and/or m-DCI functionalities of network over SIB. For example, the network node 120 can broadcast an enumeration indicating s-DCI and/or m-DCI mode of operation.

For example, the network node 120 can use a dedicated message and, for example, provide an enumeration indicating s-DCI and/or m-DCI mode of operation.

In some examples, the UE 110 can indicate a preferred DCI mode of operation scheduling, for example providing an enumeration indicating s-DCI and/or m-DCI mode of operation via rrcSetupComplete message or another uplink message. If the UE 110 does not support a network indicated DCI and/or wants single TRP operation it can exclude s-DCI/m-DCI indication in rrcSetupCompleteMessage. The s/m-DCI indication can therefore function, implicitly, as the mTRP indication 42.

The following use case will help with understanding the disclosure. A network node 120 broadcasts mTRP capability information 41 in SIB (SIB1/SIB2/new SIB). This indicates the network node's mTRP transmission capabilities.

The network node 120 indicates DCI mode of operation e.g. s/m-DCI mode of operation.

The UE 110 interested in mTRP operation can prioritize the cell(s) offering mTRP over other cells. The UE 110 interested in mTRP operation can shortlist all available cells (searched based on cell selection criterion 70) and give preference to mTRP enabled shortlisted cell in case the UE 110 is interested in mTRP operation.

The cell selection criteria 70 can be enhanced to consider mTRP measurements i.e. CMR (SSB) resource sets where each resource is associated with a different TRP.

The UE 110 sends an mTRP interest indication 42. For example, the random-access request 21 [Msg 1] provides the mTRP interest indication 42. For example, the radio resource control (RRC) connection request 23 e.g. rrcSetupRequest [Msg 3—scheduled transmission] provides the mTRP interest indication 42.

The selected network node 120 sends, a measurement configuration 43 to (e.g. CMR configuration i.e. CMR (SSB) resource sets to the UE 110. This can be provided via SIB or via RRC connection setup [Msg4].

Optionally, the UE 110 which has sent its mTRP interest indication in RACH/rrcRequest, can accept the provided configurations and send the acknowledgement in a rrcSetupComplete message. If CMR configuration is accepted by the UE 110, the UE 110 can send measurement reports (CSI reports for CMR sets) to the network node 120.

The UE 110 can indicate s/m-DCI support/preferences via the rrcSetupComplete message. If the UE 110 does not support a network indicated DCI and/or prefers single TRP operation it can exclude s/m-DCI indication from rrcSetupCompleteMessage.

Based on measurement report (CSI report), the network can start scheduling further control messages/data over multi-TRPs. In some examples, the measurement report 44, for example a beam measurement report 33, provides the mTRP interest indication 42.

FIGS. 7, 8 illustrate further examples of the UE 110 and the network node 120. The UE 110 can operate as previously described. The network node 120 can operate as previously described.

In at least some examples, the UE 110 comprises means for: signaling to a network node 120, before being connected to the network node 120, using a measurement report 44, that the UE has an interest in connecting to the network node 120 using multiple transceiver points.

The UE 110 can signal 53 to the network node 120 an interest in multi-transceiver point (mTRP) operation using the mTRP indication 42.

The random-access procedure and/or a connection setup procedure are before connection to the network node 120.

In at least some examples, the network node 120 comprises means for:
transmitting, before being connected to a user equipment 110, multi-transceiver point (mTRP) capability information 41 for the network node 120; and
receiving signaling, before connecting to a user equipment 110 via a beam measurement report 33 from the user equipment 110, indicating that the UE 110 has an interest in connecting to the network node 120 using multiple transceiver points.

As previously described, in at least some examples, the user equipment 110 comprises means for selecting a cell for access, in dependence upon the mTRP capability information 41 indicating that the network node 120 supports mTRP operation for the cell, and the cell satisfying a cell selection criterion 70 for access.

In some but not necessarily all examples, the means for selecting the cell for initial access, is configured to select a cell that supports mTRP operation and best satisfies the cell selection criterion 70 for initial access.

In some but not necessarily all examples, the selection criterion 70 is based on received power at the user equipment 110 for multiple transceiver points of the cell and/or received quality at the user equipment 110 for multiple transceiver points of the cell.

As previously described, in at least some examples, the user equipment 110 comprises means for:
receiving from the network node 120, before being connected to the network node 120, a measurement configuration 43 for performing reception quality measurements separately for at least two transceiver points;
performing, before being connected to the network node 120, configured reception quality measurements separately for the at least two transceiver points in dependence upon the received measurement configuration 43; and
transmitting, before being connected to the network node 120, at least a measurement report 44, to the network node 120, in dependence upon the configured reception quality measurements for the at least two transceiver points.
   In some but not necessarily all examples, the measurement report 44 indicates reception quality measurements separately for the at least two transceiver points.

In some but not necessarily all examples, the UE 110 comprises means for:
performing configured reception quality measurements separately and simultaneously for the at least two transceiver points in dependence upon the received measurement configuration 43; transmitting at least a measurement report 44, to the network node 120, in dependence upon the configured simultaneous reception quality measurements for the at least two transceiver points,
wherein the measurement report 44 indicates reception quality measurements separately for the at least two transceiver points wherein the reception quality measurements indicate reception quality that can be received simultaneously from the at least two transceiver points.

The measurement report 44 can be a beam measurement report 33.

In at least some examples, the UE 110 comprises means for:
receiving, from a network node 120 before being connected to the network node 120, a system information block comprising multi-transceiver point (mTRP) capability information 41 for the network node 120, wherein the mTRP capability information 41 indicates whether the network node 120 supports multiple mTRP operation in a cell; and
selecting the cell for initial access, in dependence upon the mTRP capability information 41 indicating that the network node 120 supports mTRP operation for the cell, and the cell satisfying a cell selection criterion for initial access;
in dependence upon said selection, signaling to the network node 120, before being connected to the network node 120, using a beam measurement report 33, that the UE 110 has an interest in connecting to the network node 120 using multiple transceiver points;
receiving from the network node 120, before being connected to the network node 120, a measurement configuration 43 for performing reception quality measurements separately for at least two transceiver points;
performing, before being connected to the network node 120, configured reception quality measurements separately for the at least two transceiver points in dependence upon the received measurement configuration 43;
transmitting, before being connected to the network node 120, at least a measurement report, to the network node 120, in dependence upon the configured reception quality measurements for the at least two transceiver points, wherein the measurement report indicates reception quality measurements separately for the at least two transceiver points.

In at least some examples, the network node 120 comprises means for:
transmitting, before being connected to a user equipment 110, a system information block comprising multi-transceiver point (mTRP) capability information 41 for the network node 120, wherein the mTRP capability information 41 indicates whether the network node 120 supports mTRP operation in a cell; and
receiving signaling, before being connected to the user equipment 110 via a beam measurement report 33 from the user equipment 110, indicating that the UE 110 has an interest in connecting to the network node 120 using multiple transceiver points;
transmitting, before being connected to the user equipment 110, a measurement configuration 43 for user equipment performance of reception quality measurements separately for at least two transceiver points;
receiving, before being connected to the user equipment 110, at least a measurement report, from the user equipment 110, in dependence upon the measurement configuration 43, wherein the measurement report indicates reception quality measurements separately for the at least two transceiver points.

As illustrated in FIG. 8A, in some but not necessarily all examples, the mTRP capability information 41 is provided by system information as previously described. The broadcast system information, is mandatory minimum system information. In some but not necessarily all examples, the broadcast system information is a system information block (SIB). In some but not necessarily all examples, the broadcast system information is SIB1.

The mTRP capability information 41 indicates whether the network node 120 supports mTRP operation in a cell. In some examples, the mTRP capability information 41 is comprised, at least, within channel measurements resource (CMR) of a system information block and/or wherein the mTRP capability information 41 is comprised, at least, within s/m-DCI of a system information block.

As illustrated in FIG. 8B, in some but not necessarily all examples, the mTRP capability information 41 is provided via RRC connection setup [Msg4].

In at least some preceding examples, before being connected to the network node 120, means before the UE 110 has radio resource control connection (RRC_Connection) state.

In at least some preceding examples, the (initial) access is initiated by the UE 110 transmitting, to the network node, a random access message and terminated by the UE 110 transmitting, to the network node, a first beam report or a first channel state information report after receiving a contention resolution message and/or a radio resource control connection setup message.

FIG. 9 illustrates an example of a controller 400 suitable for use in an apparatus 110, 120. Implementation of a controller 400 may be as controller circuitry. The controller 400 may be implemented in hardware alone, have certain aspects in software including firmware alone or can be a combination of hardware and software (including firmware).

As illustrated in FIG. 9 the controller 400 may be implemented using instructions that enable hardware functionality, for example, by using executable instructions of a computer program 406 in a general-purpose or special-purpose processor 402 that may be stored on a computer readable storage medium (disk, memory etc) to be executed by such a processor 402.

The processor 402 is configured to read from and write to the memory 404. The processor 402 may also comprise an output interface via which data and/or commands are output by the processor 402 and an input interface via which data and/or commands are input to the processor 402.

The memory 404 stores a computer program 406 comprising computer program instructions (computer program code) that controls the operation of the apparatus 110, 120 when loaded into the processor 402. The computer program instructions, of the computer program 406, provide the logic and routines that enables the apparatus to perform the methods illustrated in the accompanying Figs. The processor 402 by reading the memory 404 is able to load and execute the computer program 406.

The apparatus 110 comprises: at least one processor 402; and at least one memory 404 including computer program code, the at least one memory storing instructions that, when executed by the at least one processor 402, cause the apparatus at least to: signal to a network node, before being connected to the network node, using a measurement report, that the user equipment has an interest in connecting to the network node using multiple transceiver points.

The apparatus 120 comprises: at least one processor 402; and at least one memory 404 including computer program code, the at least one memory storing instructions that, when executed by the at least one processor 402, cause the apparatus at least to: transmit, before being connected to a user equipment, multi-transceiver point capability information for the network node; and receive signaling, before connecting to a user equipment via a beam measurement report from the user equipment, indicating that the user equipment has an interest in connecting to the network node using multiple transceiver points.

As illustrated in FIG. 10, the computer program 406 may arrive at the apparatus 110, 120 via any suitable delivery mechanism 408. The delivery mechanism 408 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 406. The delivery mechanism may be a signal configured to reliably transfer the computer program 406. The apparatus 110, 120 may propagate or transmit the computer program 406 as a computer data signal.

A computer program 406 comprising program instructions that when executed by one or more processors of a user equipment 110 cause the user equipment 110 to:
signal to a network node, before being connected to the network node, using a measurement report, that the user equipment has an interest in connecting to the network node using multiple transceiver points.

A computer program 406 comprising program instructions that when executed by one or more processors of a network node 120 cause the network node 120 to:
transmit, before being connected to a user equipment, multi-transceiver point capability information for the network node; and
receive signaling, before connecting to a user equipment via a beam measurement report from the user equipment, indicating that the user equipment has an interest in connecting to the network node using multiple transceiver points.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/dynamic/cached storage.

Although the processor 402 is illustrated as a single component/circuitry it may be implemented as one or more separate components/circuitry some or all of which may be integrated/removable. The processor 402 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying Figs may represent steps in a method and/or sections of code in the computer program 406. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

As used here ‘module’ refers to a unit or apparatus that excludes certain parts/components that would be added by an end manufacturer or a user. The user equipment 110 can be a module.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. An apparatus comprising:
at least one processor; and
at least one memory, the at least one memory storing instructions, that when executed by the least one processor, to cause the apparatus at least to:
signal to a network node, before being connected to the network node, using a measurement report, that the apparatus has an interest in connecting to the network node using multiple transceiver points.

2. The apparatus as claimed in claim 1 wherein the measurement report is a beam measurement report.

3. The apparatus as claimed in claim 1, wherein the instructions, when executed by the at least one processor, further cause the apparatus at least to:
receive, from the network node before being connected to the network node, broadcast system information comprising multi-transceiver point capability information for the network node; and
determine whether to perform an access to the network node, in dependence upon the multi-transceiver point capability information.

4. The apparatus as claimed in claim 3, wherein the broadcast system information is mandatory minimum system information, a system information block (SIB) or SIB1.

5. The apparatus as claimed in claim 3, wherein the multi-transceiver point capability information indicates whether the network node supports multiple transceiver point operation of a cell.

6. The apparatus as claimed in claim 3, wherein the multi-transceiver point capability information is comprised, at least, within channel measurements resource of a system information block and/or wherein the multi-transceiver point capability information is comprised, at least, within a single/multi-downlink control information (s/m-DCI) of a system information block.

7. The apparatus as claimed in claim 3, wherein the instructions, when executed by the at least one processor, further cause the apparatus at least to:
select a cell for access, in dependence upon the multi-transceiver point capability information indicating that the network node supports multiple transceiver point operation for the cell, and the cell satisfying a cell selection criterion for access.

8. The apparatus as claimed in claim 7, wherein the instructions, when executed by the at least one processor, further cause the apparatus at least to:
select a cell that supports multiple transceiver point operation and best satisfies the cell selection criterion for initial access.

9. The apparatus as claimed in claim 7, wherein the selection criterion is based on received power at the apparatus for multiple transceiver points of the cell and/or received quality at the user equipment for multiple transceiver points of the cell.

10. The apparatus as claimed in claim 3, wherein the instructions, when executed by the at least one processor, further cause the apparatus at least to:
initiate access by the apparatus transmitting, to the network node, a random access message and terminate by the apparatus transmitting, to the network node, a first beam report or a first channel state information report after receiving a contention resolution message and/or a radio resource control connection setup message.

11. The apparatus as claimed in claim 1, wherein the instructions, when executed by the at least one processor, further cause the apparatus at least to:
signal to the network node, during a random-access procedure and/or a connection setup procedure, that the apparatus has an interest in connecting to the network node using multiple transceiver points.

12. The apparatus as claimed in claim 11, wherein the signaling that the apparatus has an interest in connecting to the network node using multiple transceiver points is:
comprised within a Msg1 of a contention based random access procedure;
defined by a preamble of the random access request or Msg1;
comprised within a RRC connection request; or
comprised within a Msg 3 of a contention based random access procedure.

13. The apparatus as claimed in claim 1, wherein the instructions, when executed by the at least one processor, further cause the apparatus at least to:
receive from the network node, before being connected to the network node, a measurement configuration for performing reception quality measurements separately for at least two transceiver points; and
perform configured reception quality measurements separately for the at least two transceiver points in dependence upon the received measurement configuration; and
transmit at least a measurement report, to the network node, in dependence upon the configured reception quality measurements for the at least two transceiver points.

14. The apparatus as claimed in claim 13, wherein the measurement report indicates reception quality measurements separately for the at least two transceiver points.

15. The apparatus as claimed in claim 13, wherein the instructions, when executed by the at least one processor, further cause the apparatus at least to:
perform configured reception quality measurements separately and simultaneously for the at least two transceiver points in dependence upon the received measurement configuration;
transmit at least a measurement report, to the network node, in dependence upon the configured simultaneous reception quality measurements for the at least two transceiver point, wherein the measurement report indicates reception quality measurements separately for the at least two transceiver points wherein the reception quality measurements indicate reception quality that can be received simultaneously from the at least two transceiver points.

16. A method comprising:
signalling to a network node, before being connected to the network node, using a measurement report, that an apparatus has an interest in connecting to the network node using multiple transceiver points.

17. The method as claimed in claim 16, wherein the measurement report is a beam measurement report.

18. The method as claimed in claim 16, further comprising:
receiving, from the network node before being connected to the network node, broadcast system information comprising multi-transceiver point capability information for the network node; and
determining whether to perform an access to the network node, in dependence upon the multi-transceiver point capability information.

19. The method as claimed in claim 18, wherein the broadcast system information is mandatory minimum system information, a system information block (SIB) or SIB1.

20. The method as claimed in claim 18, wherein the multi-transceiver point capability information indicates whether the network node supports multiple transceiver point operation of a cell.
